(19) United States
(12) Patent Application Publication
(10) Pub. No.: US 2007/0024625 A1
(43) Pub. Date: Feb. 1, 2007

(54) Method, system and program storage device for 2D and 3D polyline reduction in O(N) time

(75) Inventor: Jo Gunnarshaug, Oslo (NO)

Correspondence Address: SCHLUMBERGER INFORMATION SOLUTIONS, 5599 SAN FELIPE, SUITE 1700, HOUSTON, TX, 77056-2722, US

(73) Assignee: Schlumberger Technology Corporation, Houston, TX (US)

(21) Appl. No.: 11/496,661

(22) Filed: Jul. 31, 2006

Related U.S. Application Data
(60) Provisional application No. 60/704,283, filed on Aug. 1, 2005.

(51) Int. Cl. G06T 11/20

(52) U.S. Cl. 345/441

(57) ABSTRACT

A Polyline Reduction software adapted to be stored in a workstation or other computer system solves the problem of reducing the number of points in a 2D or 3D polyline, so that it can be rendered more optimally on a computer screen or sent to a printer requiring less memory, by performing the following basic function: let Cj,k be an infinite cone with origin in Pj and a distance from Pk equal to a provided threshold distance; If Pk is inside all of the cones Ci,i+1 . . . Ci,i+2 , , , Ci,k, then points Pi+1 . . . Pi+2 . . . Pk−1 can be removed.

### CROSS REFERENCE TO RELATED APPLICATIONS

This is a Utility Application of prior pending Provisional Application Ser. No. 60/704,283 filed Aug. 1, 2005 entitled “Method System and Program Storage Device for 2D and 3D Polyline Reduction in O(N) Time”.

### BACKGROUND

This subject matter relates to a method, including a corresponding system and program storage device and computer software, that is practiced by a computer software adapted to be stored in a memory of a computer system and executed by a processor of the computer system (hereinafter called the “Polyline Reduction software”), the Polyline Reduction software, when executed by the processor of the computer system, solving a problem relating to the act of reducing the number of points in a 2D or 3D polyline thereby producing a resultant polyline, where the resultant polyline can then be either: rendered more optimally on a display screen of the computer system, or (2) sent to a printer of the computer system when that printer has an amount of memory which is less than the amount of memory which would normally be required by the printer to print a job.

A Polyline Reduction software (also called a ‘Polyline Reduction algorithm’ or a ‘Polyline Reducer algorithm’) disclosed in this specification solves a well known problem associated with reducing the number of points in a 2D or 3D polyline thereby generating a ‘resultant polyline’. As a result, the ‘resultant polyline’ can, for example, be rendered more optimally on a display screen of a computer system, or the ‘resultant polyline’ can be sent to a printer that requires less memory (that is, the printer has an amount of memory which is less than the amount of memory which would normally be required by the printer to print a print job). In addition, an increased speed (or, alternatively, a reduced execution time) is associated with the Polyline Reduction software when it is executed in a processor of a computer system, and that increased speed is exploited in order to achieve an unexpected or improved result; namely, to achieve a higher level of interactivity in 3D viewers and 2D plotting viewers when certain ‘particular applications’ are being executed in a processor of the computer system, especially those ‘particular applications’ which utilize ‘well traces’, ‘well log data’, ‘surface data’, and ‘contours’.

### SUMMARY

One aspect of the present invention involves a method of generating a reduced polyline, where ‘Cj,k’ is an ‘infinite cone’ with an origin in ‘Pj’ and a distance from ‘Pk’ equal to a provided threshold distance, the method comprising: (a) receiving an original polyline and a threshold distance; and (b) if ‘Pk’ is inside all of the cones ‘Ci,i+1 . . . Ci,i+2 . . . Ci,k’, removing points ‘Pi+1 . . . Pi+2 . . . Pk−1’ thereby generating the reduced polyline.

Another aspect of the present invention involves a program storage device readable by a machine tangibly embodying a program of instructions executable by the machine to perform method steps for generating a reduced polyline, where ‘Cj,k’ is an ‘infinite cone’ with an origin in ‘Pj’ and a distance from ‘Pk’ equal to a provided threshold distance, the method comprising: (a) receiving an original polyline and a threshold distance; and (b) if ‘Pk’ is inside all of the cones ‘Ci,i+1 . . . Ci,i+2 . . . Ci,k’, removing points ‘Pi+1 . . . Pi+2 . . . Pk−1’ thereby generating the reduced polyline.

Another aspect of the present invention involves a system adapted for generating a reduced polyline, where ‘Cj,k’ is an ‘infinite cone’ with an origin in ‘Pj’ and a distance from ‘Pk’ equal to a provided threshold distance, comprising: first apparatus adapted for receiving an original polyline and a threshold distance; and if ‘Pk’ is inside all of the cones ‘Ci,i+1 . . . Ci,i+2 . . . Ci,k’, second apparatus adapted for removing points ‘Pi+1 . . . Pi+2 . . . Pk−1’ thereby generating the reduced polyline.

Another aspect of the present invention involves a computer program adapted to be executed by a processor, the computer program, when executed by the processor, conducting a process for generating a reduced polyline, where ‘Cj,k’ is an ‘infinite cone’ with an origin in ‘Pj’ and a distance from ‘Pk’ equal to a provided threshold distance, the process comprising: (a) receiving an original polyline and a threshold distance; and (b) if ‘Pk’ is inside all of the cones ‘Ci,i+1 . . . Ci,i+2 . . . Ci,k’, removing points ‘Pi+1 . . . Pi+2 . . . Pk−1’ thereby generating the reduced polyline.

Further scope of applicability will become apparent from the detailed description presented hereinafter. It should be understood, however, that the detailed description and the specific examples set forth below are given by way of illustration only, since various changes and modifications within the spirit and scope of the ‘Polyline Reduction software’, as described and claimed in this specification, will become obvious to one skilled in the art from a reading of the following detailed description.

### BRIEF DESCRIPTION OF THE DRAWINGS

A full understanding will be obtained from the detailed description presented hereinbelow, and the accompanying drawings which are given by way of illustration only and are not intended to be limitative to any extent, and wherein:

FIG. 1 illustrates a computer system storing the Polyline Reduction software disclosed in this specification;

FIG. 2 illustrates a construction of the ‘Polyline Reduction software’ of FIG. 1;

FIG. 3 illustrates a more detailed construction of the ‘Polyline Reduction software’ of FIG. 1;

FIG. 4 illustrates the ‘basic concept’ associated with the ‘Polyline Reduction software’ with O(N) performance as disclosed in this specification;

FIG. 5 illustrates the geometry for an infinite cone and a formula for calculating the ‘spanning angle’;

FIGS. 6 through 12 illustrate a simple example of the ‘basic concept’ of FIG. 4 associated with the function performed by the Polyline Reduction software disclosed in this specification;

FIG. 13 illustrates another outcome of the example illustrated in FIGS. 6-12 showing that there are ‘jump backs’;

FIG. 14 illustrates a performance example associated with a 2D polyline having 2512 points; and

FIG. 15 illustrates a performance example associated with a 3D polyline having 1524 points.

### DETAILED DESCRIPTION

The Polyline Reduction software (also called the ‘Polyline Reduction algorithm’) disclosed in this specification solves a well known problem pertaining to the reduction of the number of points in a 2D or 3D polyline thereby generating a ‘resultant polyline’. As a result, the ‘resultant polyline’ can, for example, be rendered more optimally on a computer screen or it can be sent to a printer that requires less memory. The Polyline Reduction algorithm is faster than another ‘currently most used algorithm’. The Polyline Reduction algorithm will execute (in the processor of the computer system) in ‘linear time’ [where the term ‘linear time’ is characterized or denoted by the notation ‘O(N) time’], whereas the ‘currently most used algorithm’ will execute in ‘other time’ [where the term ‘other time’ is characterized or denoted by the notation ‘O(N*log(M)) time’], the letter ‘N’ being the number of points in the original polyline, and the letter ‘M’ being the number of points in the reduced polyline. The increased speed (or reduced execution time) associated with the Polyline Reduction software (when executed in the processor of the computer system) is exploited in order to achieve an unexpected or improved result; that is, to achieve a higher level of interactivity in 3D viewers and 2D plotting viewers associated with certain particular applications, especially those particular applications which utilize ‘well traces’, ‘well log data’, ‘surface data’, and ‘contours’.

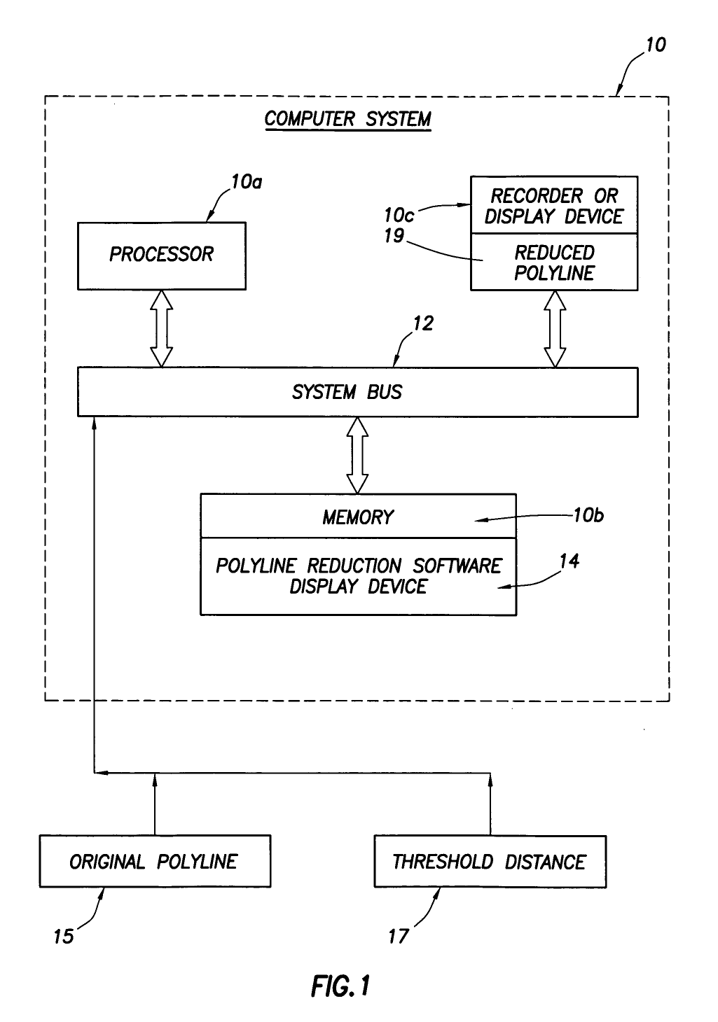

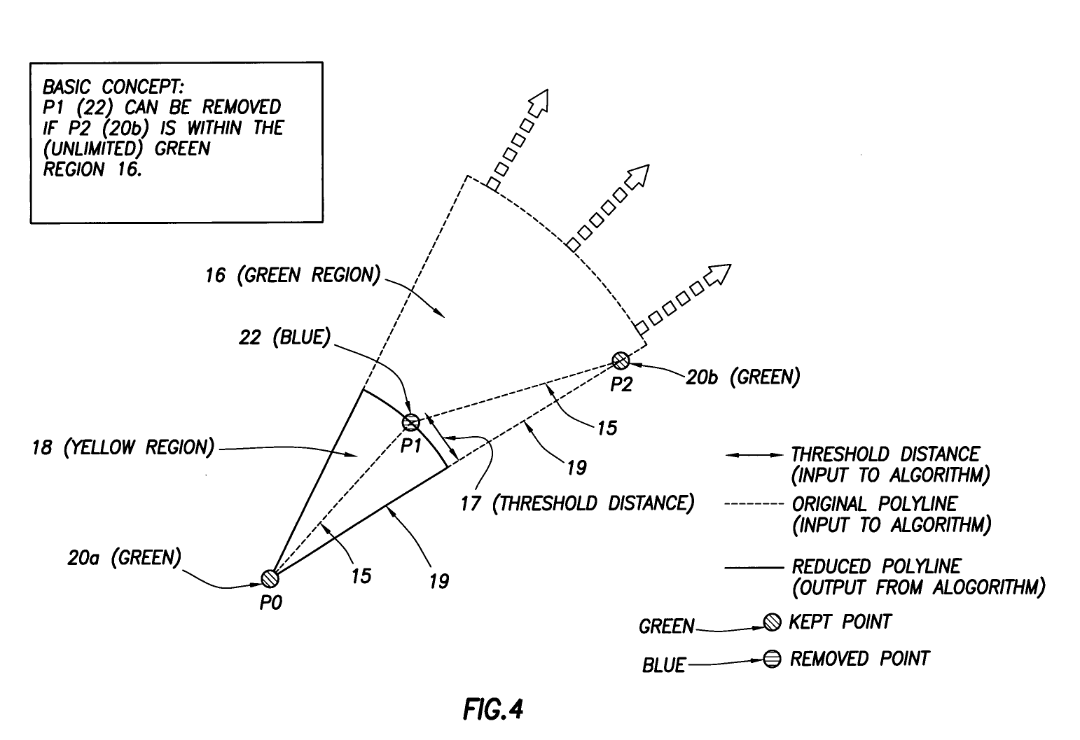

Referring to FIG. 1, a computer system 10, which stores the ‘Polyline Reduction software’ 14 of this specification, is illustrated. In FIG. 1, a workstation, personal computer, or other computer system 10 is illustrated adapted for storing the ‘Polyline Reduction software’ 14. The computer system 10 of FIG. 1 includes a processor 10a operatively connected to a system bus 12, a memory or other program storage device 10b operatively connected to the system bus 12, and a recorder or display device 10c operatively connected to the system bus 12. The memory or other program storage device 10b stores the Polyline Reduction software 14. The Polyline Reduction software 14, which is stored in the memory 10b of FIG. 1, can be initially stored on a CD-ROM or a Hard Disk, where that CD-ROM and the Hard Disk are also ‘program storage devices’. The CD-ROM can be inserted into the computer system 10, and the Polyline Reduction software 14 can be loaded from the CD-ROM (or Hard Disk) and into the memory/program storage device 10b of the computer system 10 of FIG. 1. The computer system 10 of FIG. 1 will receive ‘input data’ 15 and 17 which includes: an ‘original polyline’ 15, and (2) a parameter known as the ‘threshold distance’ 17, the original polyline 15 and the threshold distance 17 being illustrated in FIG. 4. In operation, in FIG. 1, the processor 10a will execute the Polyline Reduction software 14 stored in memory 10b while, simultaneously, using the ‘input data’ 15 and 17 including the ‘original polyline’ 15 and the ‘threshold distance’ 17, and, in response thereto, the recorder or display device 10c will generate, as output data, a ‘reduced polyline’ 19 that is adapted to be recorded by or displayed on the recorder or display device 10c. The computer system 10 may be a personal computer (PC), a workstation, or a mainframe. Examples of possible workstations include a Silicon Graphics Indigo 2 workstation or a Sun SPARC workstation or a Sun ULTRA workstation or a Sun BLADE workstation. The memory or program storage device 10b is a computer readable medium or a program storage device which is readable by a machine, such as the processor 10a. The processor 10a may be, for example, a microprocessor, microcontroller, or a mainframe or workstation processor. The memory or program storage device 10b, which stores the Polyline Reduction software 14, may be, for example, a hard disk, ROM, CD-ROM, DRAM, or other RAM, flash memory, magnetic storage, optical storage, registers, or other volatile and/or non-volatile memory.

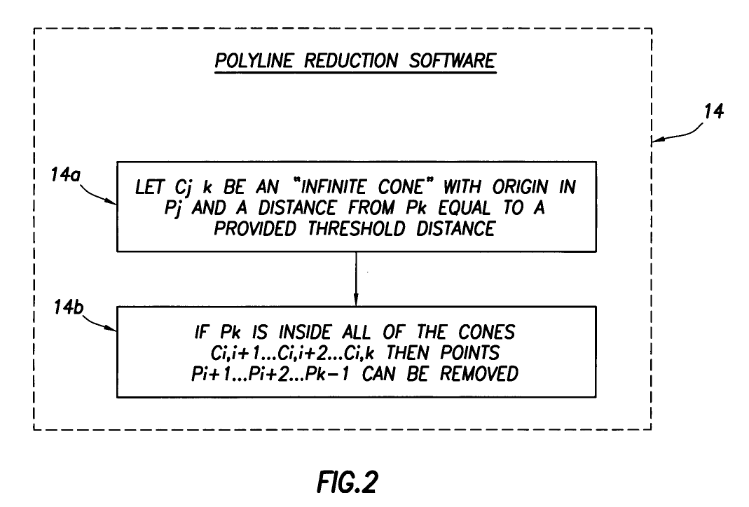

Referring to FIG. 2, a construction of the Polyline Reduction software 14 of FIG. 1 is illustrated. In FIG. 2, the Polyline Reduction software 14 of FIG. 2 includes two basic steps: (1) step 14a: Let ‘Cj,k’ be the ‘infinite cone’ with an origin in ‘Pj’ and a distance from ‘Pk’ equal to a provided threshold distance (17), and (2) step 14b: If ‘Pk’ is inside all of the cones ‘Ci,i+1 . . . Ci,i+2 . . . Ci,k’, then points ‘Pi+1 . . . Pi+2 . . . Pk−1’ can be removed.

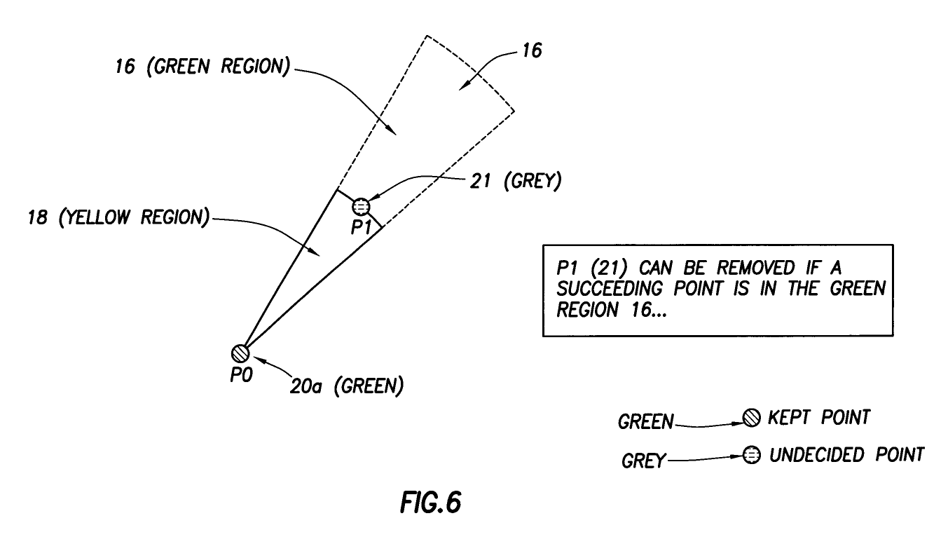

Recall that step 14b of FIG. 2 includes the following step: “If ‘Pk’ is inside all of the cones ‘Ci,i+1 . . . Ci,i+2 . . . Ci,k’, then points ‘Pi+1 . . . Pi+2 . . . Pk−1’ can be removed”. However, step 14b of FIG. 2 includes the following sub-steps (1) through (5), which will be discussed in the ‘example’ below with reference to FIGS. 6 through 12, as follows:
(1) The iteration starts at endpoint ‘P1’ (which is always added to the result); At ‘P2’, the infinite cone ‘C12’ is calculated;
(2) If ‘P3’ is inside ‘C12’, then ‘P2’ can be removed;
(3) A new cone ‘C13’ is calculated, still with origin in ‘P1’, but now with the specified threshold distance to ‘P3’;
(4) If ‘P4’ is inside the intersection of cones ‘C12’ and ‘C13’, then points ‘P2’ and ‘P3’ can be removed; and
(5) The subsequent points are inspected until the union intersection has collapsed.

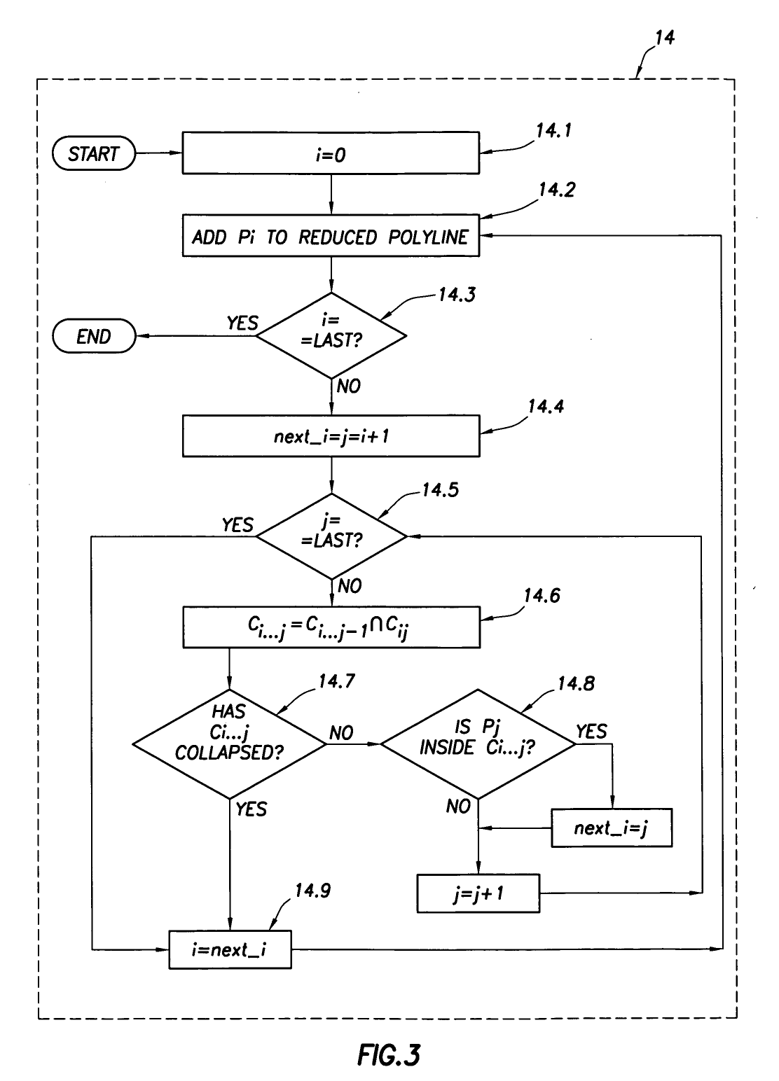

Each of the above sub-steps (1) through (5) referenced above, which together comprise step 14b of FIG. 2, will be discussed in more detail in the following paragraphs with reference to FIG. 3.

The Polyline Reduction software 14 of FIG. 1, also known as the ‘Polyline Reduction algorithm’ 14, begins by receiving the points (P1, P2, . . . ,PN) of an ‘original polyline’ 15. The Polyline Reduction software 14 will iterate through the points (P1, P2, . . . ,PN) of the ‘original polyline’ 15, starting with the first point ‘P1’ and ending with the last point ‘PN’; and, as a consequence, the Polyline Reduction software 14 thus achieves a ‘linear execution time’ in ‘N’. In FIG. 2, see step 14a which reads: “Let ‘Cj,k’ be the ‘infinite cone’ with an origin at ‘Pj’ and a distance from ‘Pk’ equal to a provided threshold distance”, where the ‘threshold distance’ 17 represents one of the ‘input data’ 17 illustrated in FIG. 1.

The ‘basic concept’ associated with the ‘Polyline Reduction algorithm’ 14 of FIG. 1 is as follows: If ‘Pk’ is inside all of the cones ‘Ci,i+1 . . . Ci,i+2 . . . Ci,k’, then points ‘Pi+1 . . . Pi+2 . . . Pk−1’ can be removed (step 14b of FIG. 2). As noted above, the iteration starts at endpoint ‘P1’, which is always added to the result; and, at ‘P2’, the infinite cone ‘C12’ is calculated. If ‘P3’ is inside ‘C12’, then ‘P2’ can be removed. Next, a new cone ‘C13’ is calculated, still with origin in ‘P1’, but now with the specified threshold distance (17) to ‘P3’. If ‘P4’ is inside the intersection of cones ‘C12’ and ‘C13’, then points ‘P2’ and ‘P3’ can be removed. The subsequent points are inspected until the union intersection has collapsed.

The Polyline Reduction algorithm 14 shows ‘O(N)’ performance for the practical cases considered. The ‘intersection-operation’ is associated with the ‘efficiency’ of the ‘Polyline Reduction algorithm’ 14 because it accumulates the required geometric knowledge into a single simple object; that is, a ‘cone with infinite range’. The intersection operation in 2D is trivial since the cones have the same origin. In the 3D case, it is harder because the intersection of two cones is not a cone. However, the largest inscribed cone can be used instead. This only produces a minor limitation, which is that poly-lines with a lot of “twisting” are not always optimally reduced. In other words, the opposite case is a polyline that completely lies in a plane. In this case, the simplified ‘intersection operation’ does not (in theory) introduce any changes to the result of the reduction.

Referring to FIG. 3, a more detailed construction of the Polyline Reduction software 14 of FIGS. 1 and 2 is illustrated.

In FIG. 3, step 14a of FIG. 2 (i.e., “Let ‘Cj,k’ be the ‘infinite cone’ with an origin in ‘Pj’ and a distance from ‘Pk’ equal to a provided threshold distance 17”) and step 14b of FIG. 2 (i.e., “If ‘Pk’ is inside all of the cones ‘Ci,i+1 . . . Ci,i+2 . . . Ci,k’, then points ‘Pi+1 . . . Pi+2 . . . Pk−1’ can be removed”) can, together, be characterized or represented by the steps shown in FIG. 3. In FIG. 3, in the first step 14.1 of FIG. 3, the Polyline Reduction algorithm 14 is initialized. For example, an index variable ‘i’ is initialized to zero, referring to the first point in the original polyline. Note that the first point will always be added to the reduced polyline. In step 14.2 of FIG. 3, the point ‘Pi’ is added to the reduced polyline. For example, only the index needs to be remembered. In steps 14.3 and 14.5 of FIG. 3, the Polyline Reduction algorithm 14 (of FIG. 1) checks if the last point has been reached. In step 14.4 of FIG. 3, index variables ‘j’ and ‘next_i’ are introduced and initialized to the next point after ‘i’. In step 14.6 of FIG. 3, region ‘Ci . . . j’ is calculated. This can be calculated as the intersection between the previous region ‘Ci . . . j−1’ and cone ‘Cij’. If the polyline is in 2D, then ‘Ci . . . j’ is itself a cone and, in 3D, it can be approximated as a cone. Note that, initially, when ‘j=i+1’, then the intersection operation is not required (‘Cii’ can be deemed equal to the entire region and ‘Cij’ can be used directly). In step 14.7 of FIG. 3, this step 14.7 checks if the region ‘Ci . . . j’ has collapsed. In step 14.8 of FIG. 3, this step 14.8 checks if ‘Pj’ can be used as the next point in the reduced polyline (thus removing points ‘Pi+1 . . . Pi+2 . . . Pj−1’). This step also demands that the distance from ‘Pi’ to ‘Pj’ is larger than the distance from the current ‘Pi’ to ‘Pnext_i’. In step 14.9 of FIG. 3, this step 14.9 initiates ‘i’ to the next point in the reduced polyline (‘next_i’), which is the result of steps 14.4 through 14.8. It represents a jump-back in the Polyline Reduction algorithm 14, but it does not make the algorithm ‘O(N*log(N))’ under the assumption that the number of jump-backs per point is restricted by a constant ‘k’ (typically k=2). The Polyline Reduction algorithm 14 is then: O(k*N)=O(N).

Referring to FIG. 4, an illustration or example of the Polyline Reduction software 14 of FIG. 1, with O(N) performance, will be discussed below with reference to FIG. 4. In FIG. 4, note the ‘original polyline’ 15 and the ‘threshold distance’ 17 which represent the ‘input data’ for the computer system 10 of FIG. 1, and note further the ‘reduced polyline’ 19 which represents the ‘output data’ 19 that is generated by the computer system 10 of FIG. 1. In addition, in FIG. 4, note the location of green region 16, yellow region 18, the points 20a and 20b, and a point 22. In FIG. 4, the ‘basic idea’ or ‘basic concept’ inherent in the Polyline Reduction software 14 of FIGS. 1-3 can be stated as follows: point P1 (which is point 22) can be removed if point P2 (which is point 20b) is within the (unlimited) green region 16. In FIG. 4, since point (P2) 20b is within the (unlimited) green region 16, point (P1) 22 can be removed. Thus, as shown in FIG. 4, point (P2) 20b is a ‘kept point’ and point (P1) 22 is a ‘removed point’.

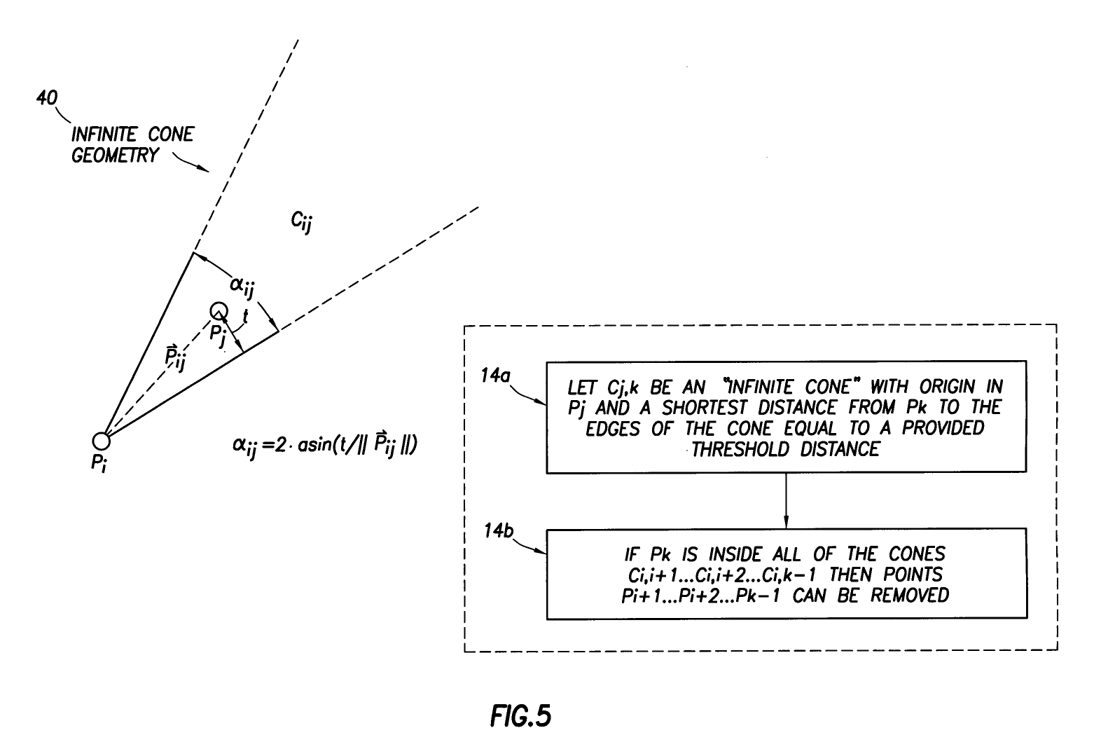

Referring to FIG. 5, the geometry for an infinite cone and a formula for calculating the ‘spanning angle’ is illustrated. In FIG. 5, the ‘basic principle’ associated with the method practiced by the Polyline Reduction software 14 of FIG. 1, as illustrated in FIG. 2, is shown again in FIG. 5, as follows: (1) step 14a: Let ‘Cj,k’ be an ‘infinite cone’ with origin in ‘Pj’ and a shortest distance from ‘Pk’ to the edges of the cone equal to a provided threshold distance (17), and (2) step 14b: If ‘Pk’ is inside all of the cones ‘Ci,i+1 . . . Ci,i+2 . . . Ci,k’, then points ‘Pi+1 . . . Pi+2 . . . Pk−1’ can be removed. The ‘basic principle’ associated with steps 14a and 14b in FIG. 5 can best be illustrated by referring to the ‘Infinite Cone Geometry’ 40 also illustrated in FIG. 5. Note, with respect to the ‘Infinite Cone Geometry’ 40 of FIG. 5, the ‘spanning angle’ αᵢⱼ. The ‘spanning angle’ αᵢⱼ can be calculated in accordance with the following equation, as shown in FIG. 5, as follows:

$${α}_{ij} = 2 \cdot a sin ( \frac{t}{‖ {\vec{P}}_{ij} ‖} )$$

Referring to FIGS. 6 through 12, an ‘example’ of the ‘function’ practiced by the Polyline Reduction software 14 of FIGS. 1, 2, and 3 is illustrated. The ‘basic idea’ or ‘basic concept’ associated with the ‘function’ practiced by the Polyline Reduction software 14 was stated above with reference to FIG. 4: “Point (P1) 22 can be removed if point (P2) 20b is within the (unlimited) green region 16”. The ‘example’ of FIGS. 6 through 12 will further exemplify this ‘basic concept’

In FIG. 6, noting the green region 16, the point P1 can be removed if a succeeding point is in the green region 16. Point P0 (being a green point 20a) is a ‘kept point’ and point P1 (being a grey point 21) is an ‘undecided point’ [i.e., it is ‘undecided’ whether, at this time, to remove grey point P1 (21) in FIG. 6 as one of the points of the ‘reduced polyline’ 19 of FIG. 1].

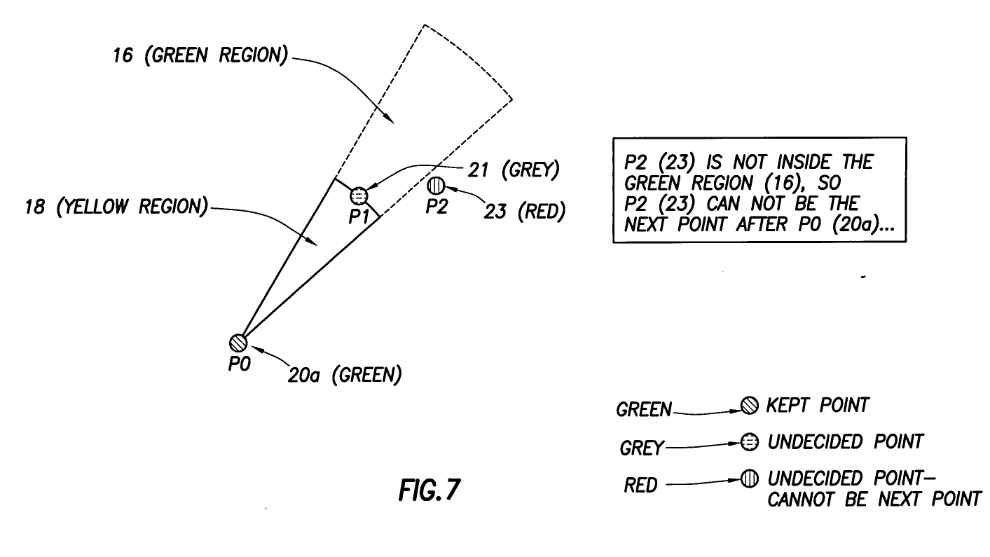

In FIG. 7, noting again the green region 16, the point P2 (which is a ‘red’ point 23) is not inside the green region 16, therefore, red point P2 (23) can ‘not’ be the next point after green point P0 (20a). Note, from the legend in FIG. 7, that ‘red’ points cannot be the next point of the ‘reduced polyline’ 19

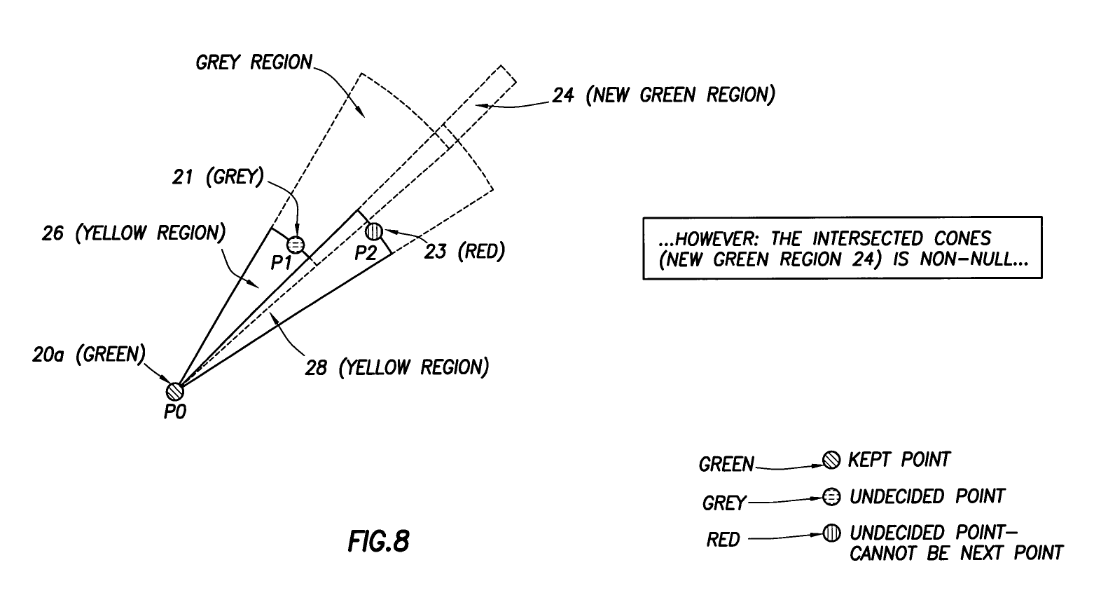

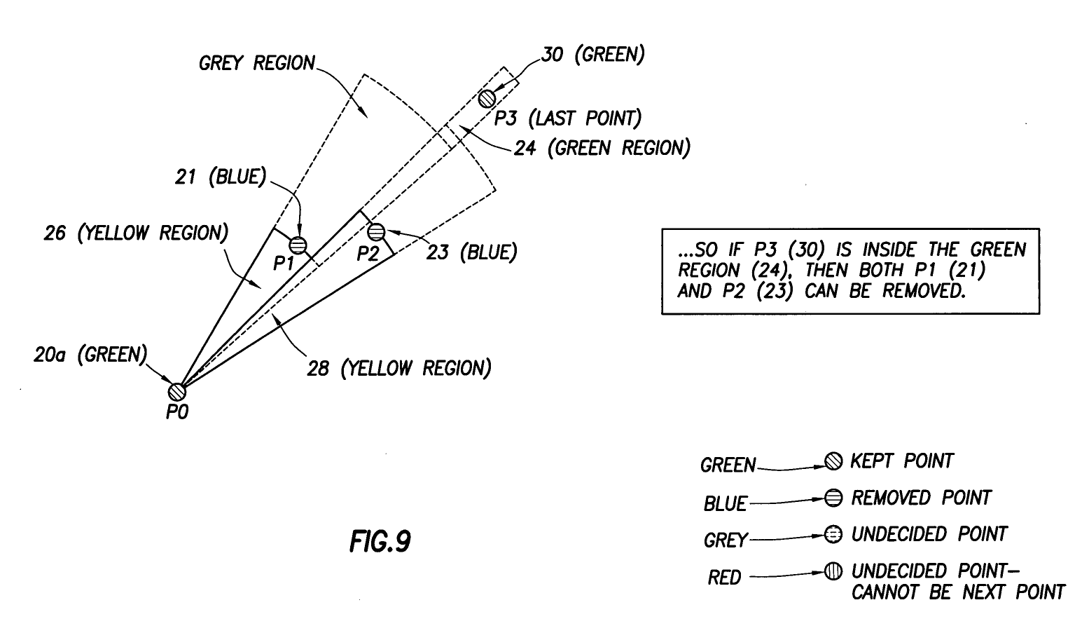

In FIGS. 8 and 9, referring initially to FIG. 8, two infinite cones 26 and 28 intersect thereby producing an ‘intersected cone’ 24 which constitutes a ‘new green region’ 24. However, the ‘intersected cone’ 24 (that is, the new green region 24) is non-null. Therefore, in FIG. 9, if point P3 (30) is inside the new green region 24 [and note that, in FIG. 9, point P3 (30) is inside the new green region 24], then both points P1 (21) and P2 (23) can be removed as points of the ‘reduced polyline’ 19 of FIG. 1. In FIG. 9, both points P1 (21) and P2 (23) are now ‘blue’ points, and a ‘blue’ point in FIG. 9 represents a ‘removed point’, where the term ‘removed point’ means that points P1 (21) and P2 (23) are not considered to be points belonging to the ‘reduced polyline’ 19 of FIG. 1.

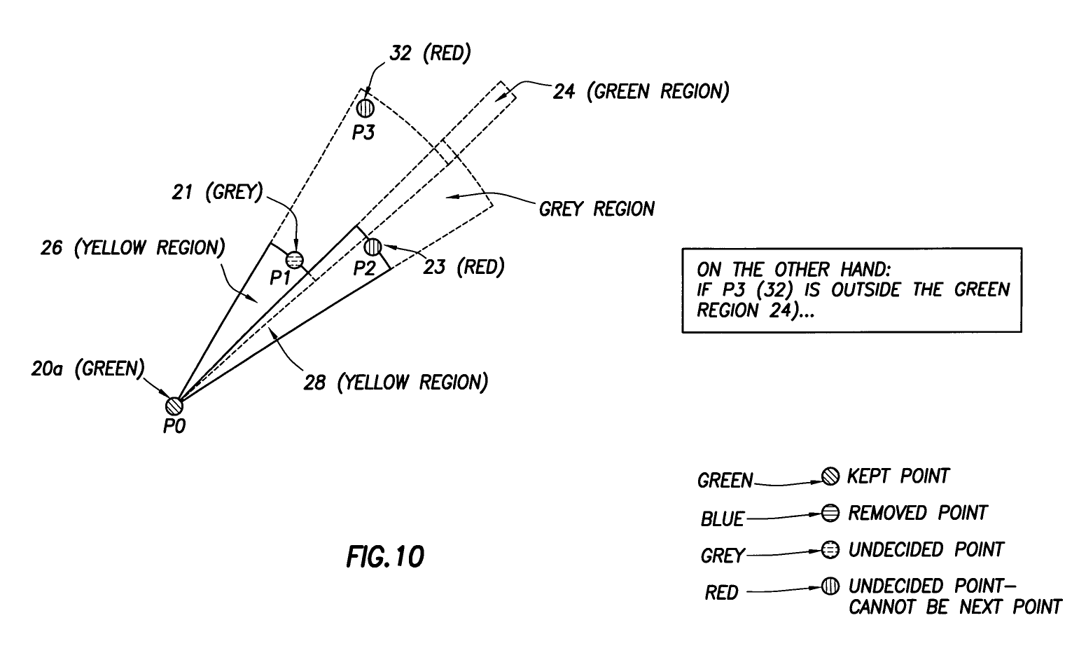

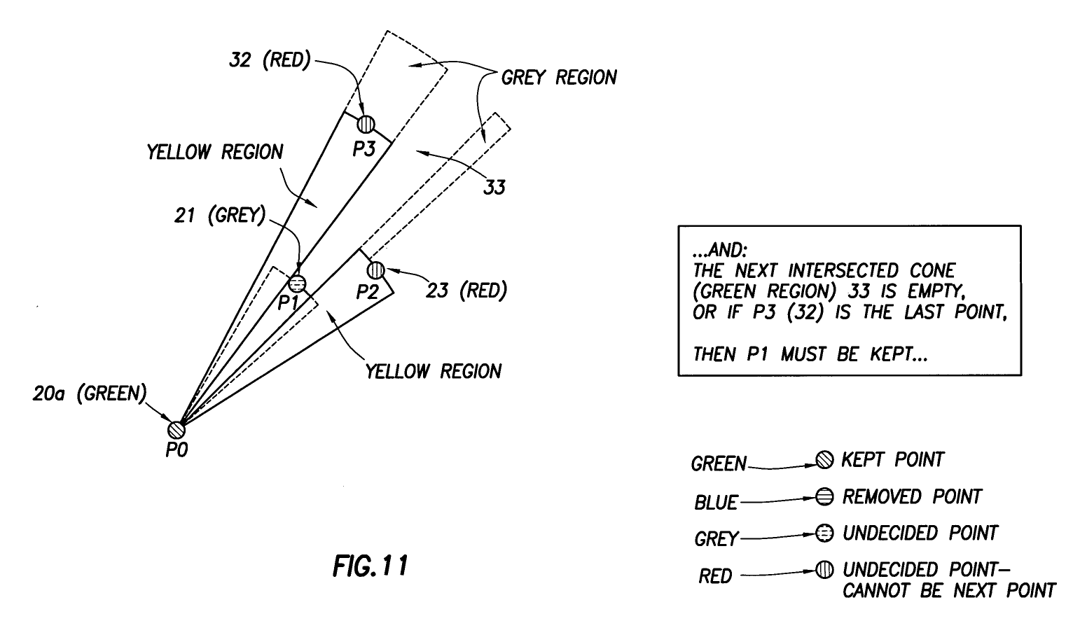

In FIGS. 10 and 11, referring initially to FIG. 10, consider the same new green region 24 of FIGS. 8 and 9. On the other hand, in FIG. 10, if the point P3 (32) is outside the green region 24 [and note that, in FIG. 10, point P3 (32) is outside the green region 24], and, in FIG. 11, if the next intersected cone (or green region) 33 is empty, or if point P3 (32) is the last point, point P1 (21) must be ‘kept’, where the term ‘kept point’ means that point P1 (21) is a member of the set of points belonging to the ‘reduced polyline’ 19 of FIG. 1. In FIG. 11, if either: (1) the next intersected cone (green region) 33 is empty, or (2) point P3 (32) is the last point, then, in that case, the point P1 (21) must be a ‘kept point’.

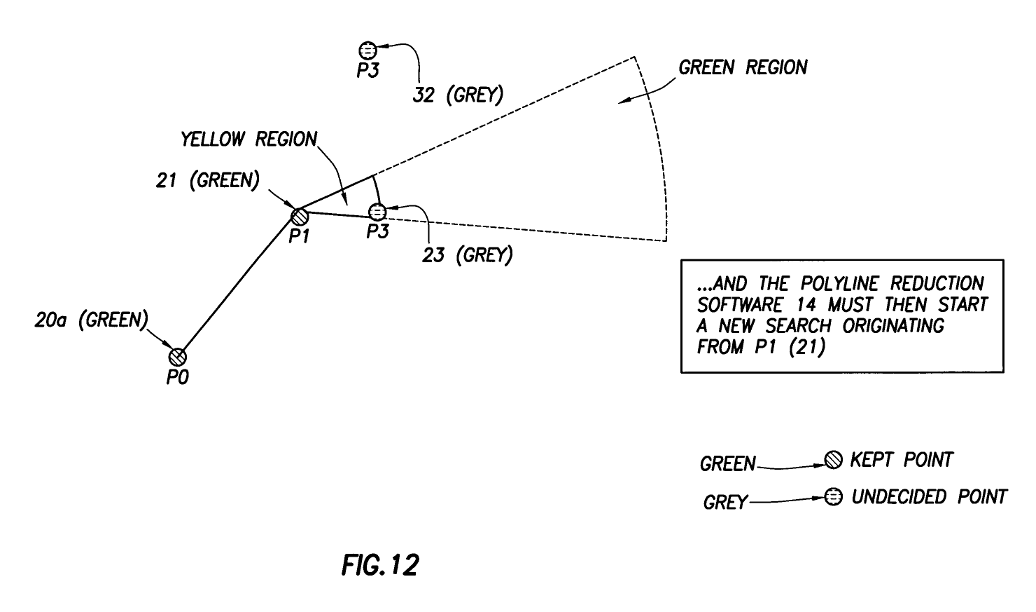

In FIG. 12, the Polyline Reduction software 14 must then start a new search originating from point P1 (21).

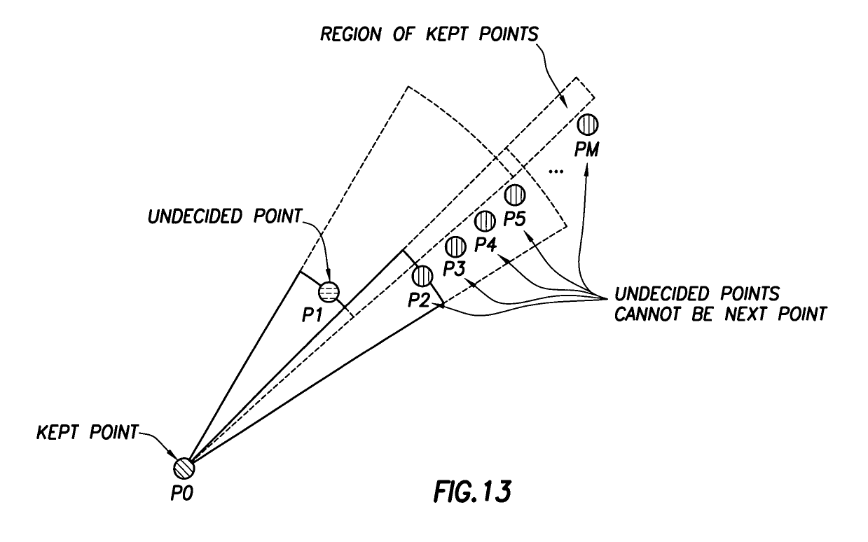

Referring to FIG. 13, another outcome of the example illustrated in FIGS. 6-12 is shown in FIG. 13 wherein there can be ‘jump backs’. Consider the example shown in FIG. 13. In FIG. 13, the second outcome of the example discussed above with reference to FIGS. 6-12 shows that there are ‘jump backs’. However, it is strongly suspected that the number of jump backs are bound; for example, that there can be no more than two (2) jump backs per point. If so, the Polyline Reduction software 14 is an O(N) algorithm.

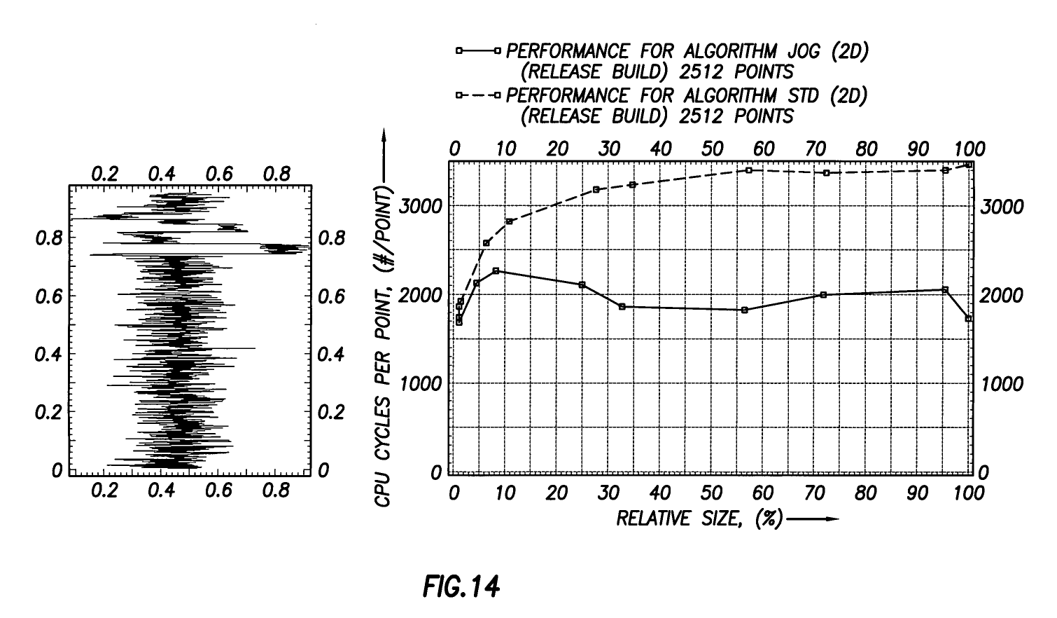

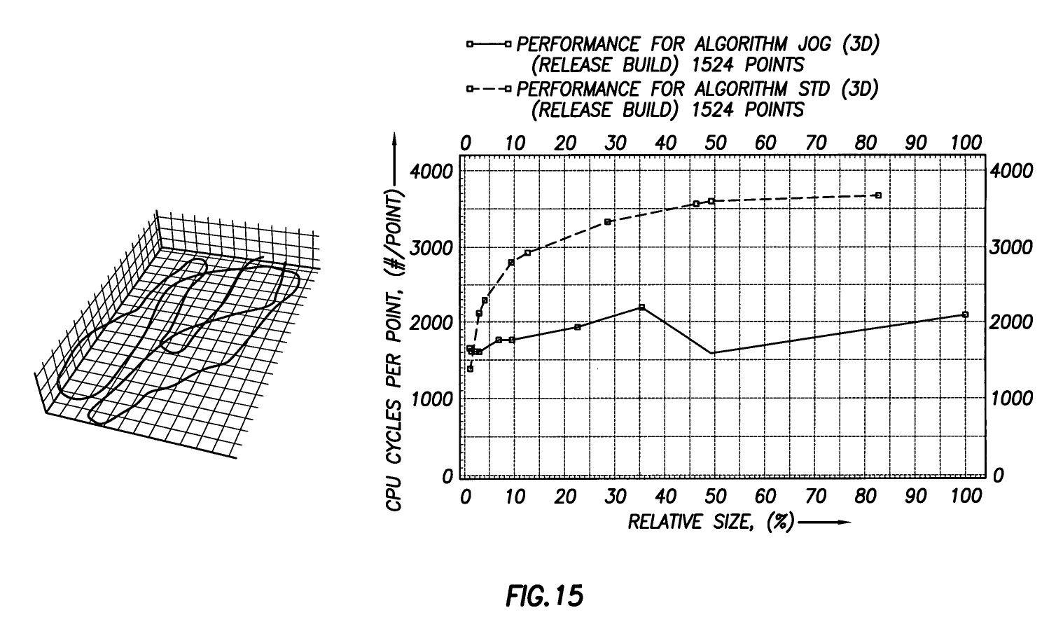

FIGS. 14 and 15 illustrate two performance examples. FIG. 14 illustrates a performance example for a 2D polyline with 2512 points, which reduced a 2D polyline with various threshold parameters, and plotted the relative size of the results (x-axis) against the execution time (y-axis) for a ‘new’ and a ‘standard’ algorithm. FIG. 15 illustrates a performance example for a 3D polyline with 1524 points, which reduced a 3D polyline with various threshold parameters, and plotted the relative size of the result (x-axis) against the execution time (y-axis) for a new and a ‘standard’ algorithm. The ‘new’ algorithm (that is, the JOG algorithm referenced in FIGS. 14 and 15) represents the Polyline Reduction software 14 of FIG. 1 that looks like an ‘O(N) algorithm’. The ‘standard’ algorithm (that is, the STD algorithm referenced in FIGS. 14 and 15) represents a ‘standard (recursive) implementation of the Douglas-Peauker algorithm (“O(M*log(N))”)’.

A functional description of the operation of the Polyline Reduction software 14 will be set forth in the following paragraphs with reference to FIGS. 1 through 15 of the drawings.

In FIG. 4, note the ‘original polyline’ 15, the ‘threshold distance’ 17, and the ‘reduced polyline’ 19. In FIG. 1, the processor 10a of the computer system 10 receives as ‘input data’ the original polyline 15 and the threshold distance 17 of FIG. 4; and, in response to that ‘input data’, the computer system 10 executes the Polyline Reduction software 14 of FIG. 1 thereby generating, as ‘output data’, the ‘reduced polyline’ 19 of FIG. 4.

In FIG. 4, when the computer system 10 executes the Polyline Reduction software 14 of FIG. 1 for the purpose of generating the ‘reduced polyline’ 19 of FIGS. 1 and 4, the Polyline Reduction software 14 will be performing a function corresponding to the following ‘basic concept’: referring to FIG. 4, “point P1 (22) can be removed if point P2 (20b) lies within the (unlimited) green region 16”. In FIG. 4, since point P2 (20b) lies within the green region 16, then, point P1 (22) can be ‘removed’; and, when point P1 is ‘removed’, then, point P1 is not a member of the set of points belonging to the ‘reduced polyline’ 19 (recall that the ‘reduced polyline’ 19 is generated as an ‘output’ by the computer system 10 of FIG. 1).

The above stated ‘basic concept’ can be described mathematically as follows with reference to FIG. 2: (1) let ‘Cj,k’ be an ‘infinite cone’ with an origin in ‘Pj’ and a distance from ‘Pk’ equal to a provided threshold distance 17 (step 14a in FIG. 2); (2) If ‘Pk’ is inside all of the cones ‘Ci,i+1 . . . Ci,i+2 . . . Ci,k’, then points ‘Pi+1 . . . Pi+2 . . . Pk−1’ can be removed (step 14b of FIG. 2).

The above stated step 14b associated with the ‘basic concept’ of FIG. 2 (namely, “If ‘Pk’ is inside all of the cones ‘Ci,i+1 . . . Ci,i+2 . . . Ci,k’, then points ‘Pi+1 . . . Pi+2 . . . Pk−1’ can be removed”) can be further described in the following five substeps (1) through (5) [where the following five substeps (1) through (5) were illustrated in the example discussed above with reference to FIGS. 6 through 12], as follows:
(1) The iteration starts at endpoint ‘P1’ (which is always added to the result); At ‘P2’, the infinite cone ‘C12’ is calculated,
(2) If ‘P3’ is inside ‘C12’, then ‘P2’ can be removed,
(3) A new cone ‘C13’ is calculated, still with origin in ‘P1’, but now with the specified threshold distance to ‘P3’,
(4) If ‘P4’ is inside the intersection of cones ‘C12’ and ‘C13’, then points ‘P2‘and ’ P3’ can be removed, and
(5) The subsequent points are inspected until the union intersection has collapsed.

The above referenced substeps (1) through (5), which together characterize step 14b in FIG. 2, can be understood by referring to the steps of the flowchart illustrated in FIG. 3.

In FIG. 3, refer to the flowchart of the Polyline Reduction software 14 which includes steps 14.1 through 14.9. In the first step 14.1, the Polyline Reduction algorithm 14 is initialized. In step 14.2, the point ‘Pi’ is added to the reduced polyline. In steps 14.3 and 14.5, the Polyline Reduction algorithm 14 (of FIG. 1) checks if the last point has been reached. In step 14.4, index variables ‘j’ and ‘next_i’ are introduced and initialized to the next point after ‘i’. In step 14.6, region ‘Ci . . . j’ is calculated. This can be calculated as the intersection between the previous region ‘Ci . . . j−1’ and cone ‘Cij’. If the polyline is in 2D, then ‘Ci . . . j’ is itself a cone and, in 3D, it can be approximated as a cone. Step 14.7 checks if the region ‘Ci . . . j’ has collapsed. Step 14.8 checks if ‘Pj’ can be used as the next point in the reduced polyline (thus removing points ‘Pi+1 . . . Pi+2 . . . Pj−1’). Step 14.9 initiates ‘i’ to the next point in the reduced polyline (‘next_i’), which is the result of steps 14.4 through 14.8. The Polyline Reduction algorithm 14 is then: O(k*N)=O(N).

The Polyline Reduction computer software 14 can be used in connection with any software product that benefits from being able to reduce large poly-lines in real-time. A typical general scenario is that a polyline is to be represented in a canvas where a lot of interactive freedom is given to the scalability/zoom-level. The Polyline Reduction software 14 can be used to optimize well traces, well-log data, surface data, and contour lines. This is displayed and/or printed in many different 3D and 2D canvases. The Polyline Reduction software 14 can also be exploited to boost the performance of other mapping software products, for example: (1) GPS-mapping tools like those used in cars and boats, (2) maps available through the internet (e.g., for looking up addresses), and (3) applications adapted for presenting a weather forecast.

The above description of the ‘Polyline Reduction software’ being thus described, it will be obvious that the same may be varied in many ways. Such variations are not to be regarded as a departure from the spirit and scope of the claimed method or system or program storage device or computer program, and all such modifications as would be obvious to one skilled in the art are intended to be included within the scope of the following claims.

We claim:

1. A method of generating a reduced polyline, where ‘Cj,k’ is an ‘infinite cone’ with an origin in ‘Pj’ and a distance from ‘Pk’ equal to a provided threshold distance, said method comprising:
(a) receiving an original polyline and a threshold distance; and
(b) if ‘Pk’ is inside all of the cones ‘Ci,i+1 . . . Ci,i+2 . . . Ci,k’, removing points ‘Pi+1 . . . Pi+2 . . . Pk−1’ thereby generating said reduced polyline.

2. The method of claim 1, wherein the removing step (b) comprises:
(b1) when an iteration starts at point P1, at point P2, calculating an infinite cone C12.

3. The method of claim 2, wherein the removing step (b) further comprises:
(b2) if a point P3 is inside the infinite cone C12, removing point P2.

4. The method of claim 3, wherein the removing step (b) further comprises:
(b3) calculating a new infinite cone C13 with origin in P1 and with a specified threshold distance to point P3.

5. The method of claim 4, wherein the removing step (b) further comprises:
(b4) if a point P4 is inside an intersection of cones C12 and C13, removing points P2 and P3.

6. The method of claim 5, wherein the removing step (b) further comprises:
(b5) repeating an inspection of subsequent points until a union intersection collapses.

7. A program storage device readable by a machine tangibly embodying a program of instructions executable by the machine to perform method steps for generating a reduced polyline, where ‘Cj,k’ is an ‘infinite cone’ with an origin in ‘Pj’ and a distance from ‘Pk’ equal to a provided threshold distance, said method comprising:
(a) receiving an original polyline and a threshold distance; and
(b) if ‘Pk’ is inside all of the cones ‘Ci,i+1 . . . Ci,i+2 . . . Ci,k’, removing points ‘Pi+1 . . . Pi+2 . . . Pk−1’ thereby generating said reduced polyline.

8. The program storage device of claim 7, wherein the removing step (b) comprises:
(b1) when an iteration starts at point P1, at point P2, calculating an infinite cone C12.

9. The program storage device of claim 8, wherein the removing step (b) further comprises:
(b2) if a point P3 is inside the infinite cone C12, removing point P2.

10. The program storage device of claim 9, wherein the removing step (b) further comprises:
(b3) calculating a new infinite cone C13 with origin in P1 and with a specified threshold distance to point P3.

11. The program storage device of claim 10, wherein the removing step (b) further comprises:
(b4) if a point P4 is inside an intersection of cones C12 and C13, removing points P2 and P3.

12. The program storage device of claim 11, wherein the removing step (b) further comprises:
(b5) repeating an inspection of subsequent points until a union intersection collapses.

13. A system adapted for generating a reduced polyline, where ‘Cj,k’ is an ‘infinite cone’ with an origin in ‘Pj’ and a distance from ‘Pk’ equal to a provided threshold distance, comprising:
first apparatus adapted for receiving an original polyline and a threshold distance; and
if ‘Pk’ is inside all of the cones ‘Ci,i+1 . . . Ci,i+2 . . . Ci,k’, second apparatus adapted for removing points ‘Pi+1 . . . Pi+2 . . . Pk−1’ thereby generating said reduced polyline.

14. The system of claim 13, wherein the second apparatus comprises:
when an iteration starts at point P1, at point P2, apparatus adapted for calculating an infinite cone C12.

15. The system of claim 14, wherein the second apparatus further comprises:
if a point P3 is inside the infinite cone C12, apparatus adapted for removing point P2.

16. The system of claim 15, wherein the second apparatus further comprises:
apparatus adapted for calculating a new infinite cone C13 with origin in P1 and with a specified threshold distance to point P3.

17. The system of claim 16, wherein the second apparatus further comprises:
if a point P4 is inside an intersection of cones C12 and C13, apparatus adapted for removing points P2 and P3.

18. The system of claim 17, wherein the second apparatus further comprises:
apparatus adapted for repeating an inspection of subsequent points until a union intersection collapses.

19. A computer program adapted to be executed by a processor, said computer program, when executed by the processor, conducting a process for generating a reduced polyline, where ‘Cj,k’ is an ‘infinite cone’ with an origin in ‘Pj’ and a distance from ‘Pk’ equal to a provided threshold distance, said process comprising:
(a) receiving an original polyline and a threshold distance; and
(b) if ‘Pk’ is inside all of the cones ‘Ci,i+1 . . . Ci,i+2 . . . Ci,k’, removing points ‘Pi+1 . . . Pi+2 . . . Pk−1’ thereby generating said reduced polyline.

20. The computer program of claim 19, wherein the removing step (b) comprises:
(b1) when an iteration starts at point P1, at point P2, calculating an infinite cone C12.

21. The computer program of claim 20, wherein the removing step (b) further comprises:
(b2) if a point P3 is inside the infinite cone C12, removing point P2.

22. The computer program of claim 21, wherein the removing step (b) further comprises:
(b3) calculating a new infinite cone C13 with origin in P1 and with a specified threshold distance to point P3.

23. The computer program of claim 22, wherein the removing step (b) further comprises:
(b4) if a point P4 is inside an intersection of cones C12 and C13, removing points P2 and P3.

24. The computer program of claim 23, wherein the removing step (b) further comprises:
(b5) repeating an inspection of subsequent points until a union intersection collapses.
